(19) United States
(12) Patent Application Publication
(10) Pub. No.: US 2012/0286102 A1
(43) Pub. Date: Nov. 15, 2012

(54) REMOTELY CONTROLLED VTOL AIRCRAFT, CONTROL SYSTEM FOR CONTROL OF TAILLESS AIRCRAFT, AND SYSTEM USING SAME

(76) Inventors: Pranay Sinha, Santa Cruz, CA (US); Jeffrey Kyle Gibboney, Menlo Park, CA (US); JoeBen Bevirt, Santa Cruz, CA (US); Piotr Esden-Tempski, Santa Cruz, CA (US); Christopher Allen Forrette, Capitols, CA (US); Gregory Mainland Horn, Hillsborough, CA (US)

(21) Appl. No.: 13/433,276

(22) Filed: Mar. 28, 2012

Related U.S. Application Data
(63) Continuation of application No. 12/566,667, filed on Sep. 25, 2009, now abandoned.
(60) Provisional application No. 61/468,562, filed on Mar. 28, 2011.
(60) Provisional application No. 61/475,767, filed on Apr. 15, 2011.
(60) Provisional application No. 61/616,843, filed on Mar. 28, 2012.

(51) Int. Cl. B64C 13/20; B64C 27/26

(52) U.S. Cl. 244/7 B; 244/189

(57) ABSTRACT

A manned/unmanned aerial vehicle adapted for vertical takeoff and landing using the same set of engines for takeoff and landing as well as for forward flight. An aerial vehicle which is adapted to takeoff with the wings in a vertical as opposed to horizontal flight attitude which takes off in this vertical attitude and then transitions to a horizontal flight path. An aerial vehicle which controls the attitude of the vehicle during takeoff and landing by alternating the thrust of engines, which are separated in at least two dimensions relative to the horizontal during takeoff, and which may also control regular flight in some aspects by the use of differential thrust of the engines. A tailless airplane which uses a control system that takes inputs for a traditional tailed airplane and translates those inputs to provide control utilizing non-traditional control methods.

### CROSS-REFERENCE TO RELATED APPLICATIONS

This application is a continuation of U.S. patent application Ser. No. 12/566,667 to Bevirt, filed Sep. 25, 2009, which is hereby incorporated by reference in its entirety. This application claims priority to U.S. Provisional Patent Application No. 61/468,562, to Esden-Tempski et al., filed Mar. 28, 2011, which is hereby incorporated by reference in its entirety. This application claims priority to U.S. Provisional Patent Application No. 61/475,767, to Bevirt, filed Apr. 19, 2011, which is hereby incorporated by reference in its entirety. This application claims priority to U.S. Provisional Patent Application No. 61/616,843, to Pranay et al., filed Mar. 28, 2012, which is hereby incorporated by reference in its entirety.

### BACKGROUND

1. Field of the Invention

This invention relates to powered flight, and more specifically to a take-off and flight control method and system.

2. Description of Related Art

VTOL capability may be sought after in manned vehicle applications, such as otherwise traditional aircraft. An unmanned aerial vehicle (UAV) is a powered, heavier than air, aerial vehicle that does not carry a human operator, or pilot, and which uses aerodynamic forces to provide vehicle lift, can fly autonomously, or can be piloted remotely. Because UAVs are unmanned, and cost substantially less than conventional manned aircraft, they are able to be utilized in a significant number of operating environments.

UAVs provide tremendous utility in numerous applications. For example, UAVs are commonly used by the military to provide mobile aerial observation platforms that allow for observation of ground sites at reduced risk to ground personnel. The typical UAV that is used today has a fuselage with wings extending outward, control surfaces mounted on the wings, a rudder, and an engine that propels the UAV in forward flight. Such UAVs can fly autonomously and/or can be controlled by an operator from a remote location. UAVs may also be used by hobbyists, for example remote control airplane enthusiasts.

A typical UAV takes off and lands like an ordinary airplane. Runways may not always be available, or their use may be impractical. It is often desirable to use a UAV in a confined area for takeoff and landing, which leads to a desire for a craft that can achieve VTOL.

### SUMMARY

A manned/unmanned aerial vehicle adapted for vertical takeoff and landing using the same set of engines for takeoff and landing as well as for forward flight. An aerial vehicle which is adapted to takeoff with the wings in a vertical as opposed to horizontal flight attitude which takes off in this vertical attitude and then transitions to a horizontal flight path. An aerial vehicle which controls the attitude of the vehicle during takeoff and landing by alternating the thrust of engines, which are separated in at least two dimensions relative to the horizontal during takeoff, and which may also control regular flight in some aspects by the use of differential thrust of the engines. A tailless airplane which uses a control system that takes inputs for a traditional tailed airplane and translates those inputs to provide control utilizing non-traditional control methods.

### BRIEF DESCRIPTION OF THE DRAWINGS

FIGS. 1A-B are illustrations of an unmanned aerial vehicle according to some embodiments of the present invention.

FIG. 2 is a sketch illustrating an airplane coordinate system.

FIG. 3 is an end view of an unmanned aerial vehicle prior to takeoff according to some embodiments of the present invention.

FIG. 4 is a top view of an unmanned aerial vehicle prior to takeoff according to some embodiments of the present invention.

FIG. 5 is an illustration of an aerial vehicle during vertical takeoff and transition to horizontal flight according to some embodiments of the present invention.

FIG. 6 is a view of an aerial vehicle according to some embodiments of the present invention.

FIG. 7 is a front view of an aerial vehicle according to some embodiments of the present invention.

FIG. 8 is a side view of an aerial vehicle according to some embodiments of the present invention.

FIG. 9 is a rear view of an aerial vehicle according to some embodiments of the present invention.

FIG. 10 is a view of an aerial vehicle according to some embodiments of the present invention.

FIG. 11 illustrates views of an aerial vehicle according to some embodiments of the present invention.

FIG. 12 illustrates views of an aerial vehicle according to some embodiments of the present invention.

FIG. 13 illustrates views of an aerial vehicle according to some embodiments of the present invention.

FIG. 14 illustrates views of an aerial vehicle according to some embodiments of the present invention.

FIG. 15 illustrates autopilot software modules according to some embodiments of the present invention.

FIG. 16 illustrates flow charts for software according to some embodiments of the present invention.

FIG. 17 illustrates the North-East-Down and body frames according to aspects of the present invention.

FIG. 18 illustrates a control system according to some embodiments of the present invention.

FIG. 19 illustrates the Euler angles in hover according to some aspects of the present invention.

FIG. 20 illustrates the NED, body, and heading frames according to some aspects of the present invention.

FIG. 21 illustrates Euler angles in forward flight according to some aspects of the present invention.

FIG. 22 presents graphs of setpoints and attitude estimates during flight according to some aspects of the present invention.

### DETAILED DESCRIPTION

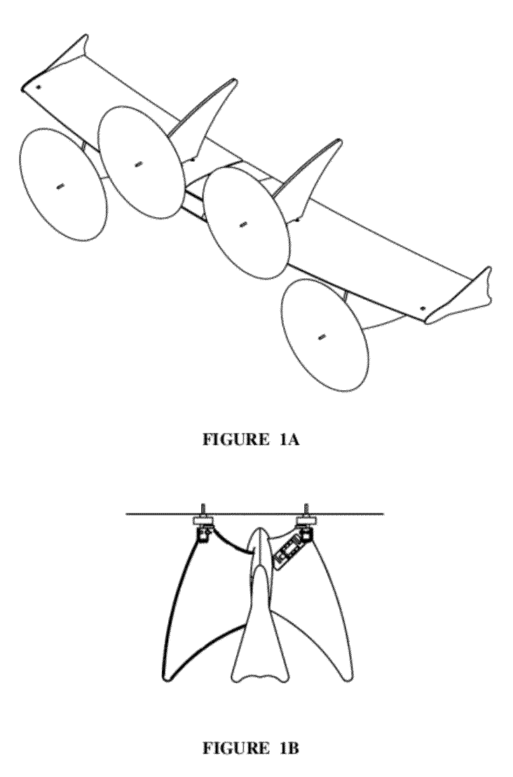

In some embodiments of the present invention, as seen in FIGS. 1A-B, an aerial vehicle 40 is seen with a first wing 41. Two thrust producing elements 45, 46 are mounted above the first wing 41, and two thrust producing elements 43, 44 are mounted below the first wing 41. The thrust producing elements 43, 44, 45, 66 are fixedly mounted to the wing 41. The thrust producing elements 43, 44, 45, 46 may be electric motors with propellers in some embodiments. With the vertical spacing between the upper and lower propellers, and the horizontal spacing between the right and left propellers, there is sufficient spacing in two axes to allow for control of the aerial vehicle 40 using thrust differentiation. In the case of vertical take-off and landing, thrust differentiation may be used to maintain attitude with the propellers facing predominantly upward, as the sole means of control or in addition to the use of control surfaces on the aerial vehicle 40. In the case of regular or acrobatic flight, pitch and yaw control may be accomplished using solely thrust differentiation, or in addition to the use of control surfaces on the aerial vehicle 40.

In some embodiments, one or more electronics packages may be mounted on or within the wing structure. The electronics packages may include control electronics for the aerial vehicle which may further include attitude sensors as well as motor control electronics. In some embodiments, the thrust producing elements 43, 44, 45, 46 are electric motors. Batteries to power the electric motors may be mounted within the electronics packages, or at other locations on or within the aerial vehicle 10.

Although not clearly illustrated in FIGS. 1A-B, in some embodiments the aerial vehicle 40 may have control surfaces such as ailerons attached to the wing structure. In some embodiments, the aerial vehicle 40 may have ailerons on one or more of its wings which are adapted for roll control. In some embodiments, a system for flying an aerial vehicle 40 may include a remote control unit adapted to be controlled by a user on the ground. In some embodiments, such as with the tailless as seen in FIGS. 1A-B, the remote control unit may be adapted to receive inputs from the user as would be used to control a regular aircraft with a tail, for example elevator and rudder inputs. The control system on the aerial vehicle may then translate these inputs for control of the tailless aerial vehicle so that the tailless aerial vehicle responds as if it were a tailed aircraft. In some aspects, the translated control commands sent by the aerial vehicle's onboard control system may include thrust differentiation, movement of control surfaces, or a combination of thrust differentiation and movement of control surfaces.

In some embodiments, the control system is adapted to recover the heading and the attitude of the aerial vehicle. In some embodiments, the user controls the heading and attitude of the aerial vehicle using a remote control unit, and then the onboard control system can maintain this heading and attitude without further input from the remote control unit. For example, should a strong gust blow the vehicle off heading, the control system may reacquire the heading and attitude of the aerial vehicle as it was prior to the disturbance. In another example, the control system may compensate for heading and/or attitude changes due to loss of lift during a turn, for example, such that only the heading or attitude changes directed by the user are realized by the vehicle.

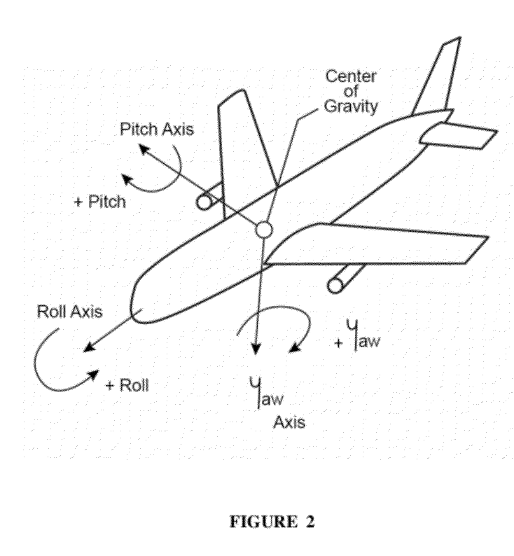

FIG. 2 illustrates a reference frame fixed relative to the aircraft which is used in the description of axes herein. In horizontal, nominal flight, the direction in which the aerial vehicle flies is referred to as the nominal flight direction. In a biplane configuration, one of the wings, for example the upper wing, may lead the other wing slightly as a stagger which is part of the vehicle design. Thus, when constructing a geometric plane across the leading edges of the two wings, and then constructing a perpendicular line forward from that plane, the constructed line may not point in the flight direction due to the stagger of the wings. The nominal flight direction is an axis forward from the vehicle representing the direction in which the vehicle is flying when in horizontal type flight.

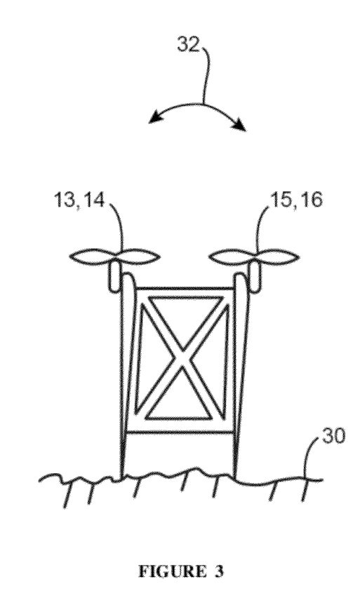

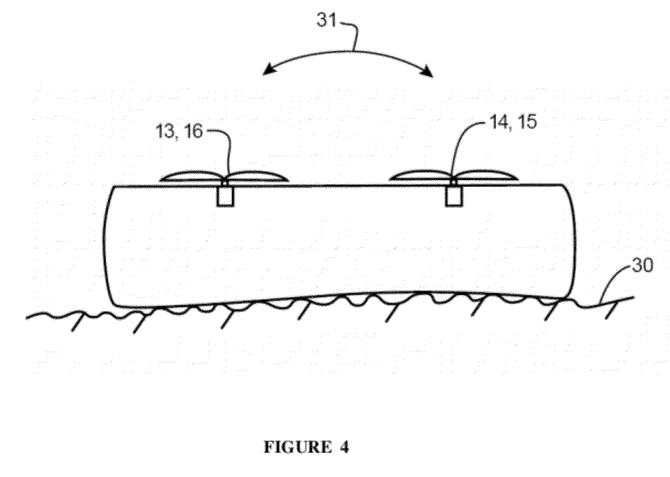

FIG. 3 is an illustration of a side view of an aerial vehicle 10 laying on the ground 30 with the thrust producing elements 13, 14, 15, 16 facing skyward. FIG. 4 is an illustration of a top view of an aerial vehicle 10 laying on the ground 30 with the thrust producing elements 13, 14, 15, 16 facing skyward. Although illustrated as the rear of the wings 11, 12 being on the ground 30, there may be structure on the aerial vehicle, attached to the wings or other portions of the aerial vehicle, adapted to allow the mass of the aerial vehicle to be supported in this position. In some embodiments, the vehicle may be adapted to rest facing skywards in water, either using the buoyancy of the wings or through some other method. Although FIGS. 2, 3, and 4 illustrate a biplane, the discussion herein applies equally to a single wing aircraft as seen in FIGS. 1A-B.

Using the aircraft based coordinate system as illustrated in FIG. 2, the heading change 32 illustrated in FIG. 3 would be a change of pitch. Using the aircraft based coordinate system as illustrated in FIG. 3, the heading change 31 illustrated in FIG. 4 would be a change in yaw. In a vertical takeoff scenario, the thrust producing elements 13, 14, 15, 16 are varied in power output in order to either change, or maintain, pitch and yaw. For example, to effect a pitch change (in aircraft based coordinates), the relative power output of the thrust producing elements 13, 14 associated with the lower wing 11 can be varied relative to the power output of the thrust producing elements 15, 16 associated with the upper wing 12. To effect a yaw change, the relative power output of the left side thrust producing elements 13, 16 can be varied relative to the power output of the right side thrust producing elements 14, 15. In this way, the aerial vehicle can be raised from the ground in a vertical takeoff scenario while maintaining control of pitch and yaw.

In some embodiments, the aerial vehicle may use a sensor package adapted to provide real time attitude information to a control system which is adapted to perform a vertical takeoff while maintaining the ground position of the aerial vehicle. The control system may be autonomous in keeping the ground attitude while an operator commands an altitude raise while in takeoff mode. With the aerial vehicle adapted to take off from a position wherein the leading edges of the wings and the engines face skywards, no relative motion of the engines and the wings is necessary to achieve vertical take off and landing.

The spacing of the thrust producing elements in two dimensions as viewed from above when the aerial vehicle is on the ground ready for takeoff allows the engine power differentials to control the aircraft in the pitch and yaw axes. Although four thrust producing elements are illustrated here, the two dimensional spacing needed for two dimensional control could be achieved with as few as three engines.

Although the control of pitch and yaw has been discussed, in some embodiments the roll axis may also be controlled. In some embodiments, the thrust producing elements may be engines which rotate in different directions. The powering up and down of engines which are rotating in opposite directions along the roll axis will create torque along the roll axis, which allows for control of the aircraft along that axis. In some embodiments, the roll control during takeoff and landing may be controlled using ailerons.

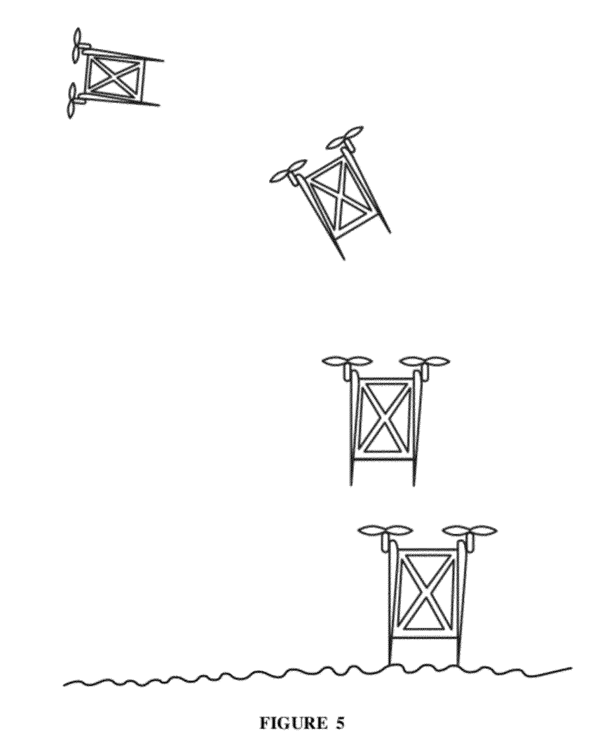

FIG. 5 illustrates the transition from vertical takeoff to horizontal flight according to some embodiments of the present invention. As seen, the aerial vehicle first engages in vertical takeoff while maintaining attitude control using an onboard sensor package and by varying the power output of the engines to maintain attitude in a desired range, and may also use the ailerons for control in a third axis. As the aerial vehicle is raised to a desired altitude, the transition to horizontal flight begins. With the use of differential power output control of the engines, the aerial vehicle is pitched forward, which alters the wings from their skyward facing position to a more horizontal, normal flying position. This forward pitching of the aerial vehicle also causes the vehicle to begin to accelerate forward horizontally. With the increase in horizontal velocity coupled with the wing airfoils attitude change to a more horizontal position, lift is generated from the wing airfoils. Thus, as the engines are transitioned to a more horizontal position and their vertical thrust is reduced, lift is begun to be generated from the wing airfoils and the altitude of the aerial vehicle is maintained using the lift of the wings. In this fashion, the aerial vehicle is able to achieve vertical takeoff and transition to horizontal flight without relative motion of the engines to the wings, and using differential control of the power of the engines to achieve some, if not all, of the attitude changes for this maneuver. When landing the craft, these steps as described above are reversed. In some embodiments, as discussed further below, vehicle attitude control may be achieved with a combination of differential thrust control and the use of control surfaces on the aerial vehicle.

The control system adapted for control of pitch and yaw during takeoff using differential control of the thrust elements, which may be electric motors with propellers in some embodiments, is also adapted to be used during traditional, more horizontal flight. Although the aerial vehicle may also use control surfaces during takeoff in some embodiments, the aerial vehicle and its control system are adapted to use differential control of the thrust elements to vary pitch and yaw, and in some embodiments, to control roll as well.

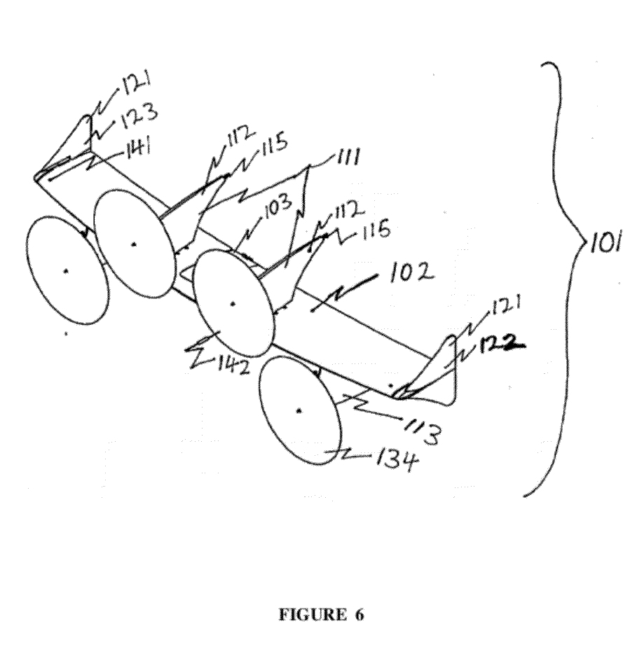

FIG. 6 is a sketch depicting an embodiment of the present invention in a perspective view. The aerial vehicle 101 may have a curved planform main wing 102 made up of custom symmetric airfoil sections joined together with splines. The advantage of using symmetric airfoils is that the lift generating force acts (center of lift) at roughly the same location on the airfoil (either main or plus airfoil) at different angles of attack. With a tailless aircraft, there are advantages to maintaining the center of lift within a narrowly constrained area for stability of control reasons. If the center of gravity of the vehicle is placed at the location in which the lift force acts, there is little to no moment exerted by the action of gravity and lift, allowing the aircraft to fly despite having no tail. In some embodiments, the main wing may be made up of asymmetric, reflex camber airfoils. Reflex camber airfoils have a traditional camber for the most part but have a reverse camber towards the trailing edge, creating a situation where the front of the airfoil produces lift while the back creates relative downforce. This also allows a tail-less aircraft to maintain a close to zero-moment in the pitch axis, reducing the trim required to hold a set pitch attitude. This reduces drag and therefore makes flight more efficient.

In the case wherein the pylons also have airfoil profiles, the use of a symmetric profile also maintains the center of lift within a narrow space in a second axis. Symmetric airfoils and symmetric pylons thus lead to a situation where the center of lift of the overall vehicle will remain within a very tight area (as compared to any other type of scenario).

In some embodiments, the tips of the wing 102 have triangular actuated aerodynamic surfaces which are mounted perpendicular to the chord line of the main wing 102 and aligned with the direction of oncoming airflow in forward flight. These triangular aerodynamic components on the ends of the main wing 102 are called winglets 121. When an aircraft flies through the air, the main wing 102 generates lift by pushing air downward. During this process of air being pushed downward by the main wing 102, it is also pushed outward to the tips in a phenomenon known as spanwise flow which curls up at the tips of the wings to create wingtip vortices. These vortices manifest themselves as lift induced drag on the main wing 102. The winglets 121 interact with the wingtip vortices and weaken them, thereby reducing induced drag. Furthermore, the winglets 121 provide vertical surface area that is behind the center of gravity of the vehicle, thus providing stabilizing force in the yaw axis, much like the vertical tail does in a conventional aircraft. In some embodiments, the winglets 121 may be different shapes or sizes or may be blended into the main wing 102 using a smooth curve rather than a discrete angle.

The vehicle 101 is provided force to take off vertically and is also propelled through the air in a forward direction using a set of four motors with propellers mounted on them. FIG. 1 displays the disc created by these four spinning propellers 134. The motors/propellers are mounted to the aircraft 101 by means of motor pylons 111. The motor pylons 111 have attachment receptacles for motor on one end and are connected to the top surface of the main wing 102 in the form of top motor pylons 112 and to the bottom of the main wing 102 in the form of bottom motor pylons 113. The motor pylons 111 are aerodynamic structures made up of symmetric airfoils. The airfoil shape reduces the drag coefficient of the motor pylon structure, thus increasing endurance and range of the vehicle 101. In some embodiments, the bottom motor pylons 113 are placed further apart from each other than the top motor pylons 112 in order to allow the placement of payloads such as, but not limited to, a camera on the bottom surface of the main wing 102 near the middle of the span of the main wing 102 such that the center of gravity of the vehicle 101 is close to the spanwise center such that roll trim is not required in flight, thereby reducing cruise drag and therefore increasing range and endurance. The increased separation between the bottom pylons 113 allows the payload mounted to the underside of the main wing 102 to have an unobstructed forward-looking view, which is beneficial in case the payload is a camera or other sensor. Landing pads 115 may be seen at the rear of each pylon 111 for use when the vehicle is on the ground.

The main wing 102 has embedded in its center section an electronics bay 103 that contains the avionics hardware and power source (battery) as well as the Inertial Measurement Unit (IMU), which is the primary sensor used to determine the vehicle's angular orientation or attitude in flight. The location of the IMU near the geometric center of the vehicle eliminates the necessity of taking into account linear separation of the sensor from the center of the vehicle, thereby reducing the number of math operations required to calculate the vehicle attitude from the sensor inputs, thus reducing the workload of the on-board processor.

In an exemplary embodiment of the aerial vehicle 101, the main wing is a 1 m span 0.1625 m average chord planform with an elliptically swept leading edge. The center section houses an avionics and battery enclosure that conforms to the root airfoil shapes, thus making it a lifting body. The wing also tapers from 0.175 m at the root to 0.15 m at the tips with an overall sweep angle of 6. The main wing utilizes custom symmetric PST04 and PST76 airfoils for high maximum lift coefficient CLmax and glide ratio while meeting the manufacturing requirement of a minimum 3.0 mm trailing edge. The choice of symmetric airfoils is driven by the desire to be able to operate inverted without significant impact on flight characteristics.

The swept and tapered vertical pylons use symmetric PS0024 and PS0013.33 sections with 0.1625 m average chord, 0.1 m span. The sizing is chosen at least in part to provide an adequate base for stable landings, clearance for propeller blades and a large enough moment arm to allow quick pitch maneuvers. Additionally, the vertical pylons also provide lateral force to prevent side-slip in turns and relaxed spiral stability. The airfoil selection for the vertical pylons is also governed by manufacturing and robustness concerns, with the minimum trailing edge thickness limited to 4.5 mm without the option of using a splitter plate to reduce associated drag effects. The staggered quadrotor configuration also increases pitch inertia and propeller damping to create a more controllable system, while providing a clear center section underneath the wing for unobstructed placement of cameras or other payloads.

The vehicle design mass is 0.7 kg with motor/propeller combinations chosen to provide a thrust to weight ratio for the vehicle of 3. The motor/propeller/aerodynamic surface combination also allows a theoretical full rotation about pitch and yaw in 0.283 s and 0.512 s respectively from zero initial angular velocity. Furthermore, elevons assisted by differential torque allow a similar rotation in roll in 0.56 s. These numbers assume only prop-wash over the surfaces and not forward velocity. The airframe was designed to achieve performance objectives while being lightweight, resistant to impact damage, and manufacturable using low-cost mass-production techniques, such as injection molding. Expanded polypropy-lene (EPP) foam is used for the bulk structure due to its low density(commonly 21 to 60 g/L), impact and crush resistance, and low cost. Nylon was selected for the avionics enclosure as it can be molded into thin-walled structures with minimal warping, and possesses good impact resistance. Uni-directionally extruded carbon fiber tube was found to possess adequate rigidity and strength, and was chosen over woven carbon fiber for the main spar due to its lower cost. Although discussed herein with regard to an exemplary embodiment, other appropriate materials may be used.

Component placement is carefully controlled to place the Center of Gravity (CG) ahead of the neutral point at all times and below the geometric center of the vehicle in the vertical direction. This provides longitudinal static stability as well as rendering a wings-level top-side-up attitude as the most passively stable one. This means that in a non-normal situation where differential thrust control is lost due to motor power being switched off as a safety measure, the vehicle does not tumble and can be made to glide down in a controlled fashion even under manual control. The existence of longitudinal static stability does not imply any lack of necessity for automatic control in any powered mode of flight. Since the thrusters are explicitly sized to be able to provide high rates of rotation using differential thrust and torque, they can easily overcome aerodynamic restoring forces if their thrust output is not “balanced” in some way. Automatic control is important for correct thrust balancing from these multiple thrusters in all modes of flight except an unpowered glide.

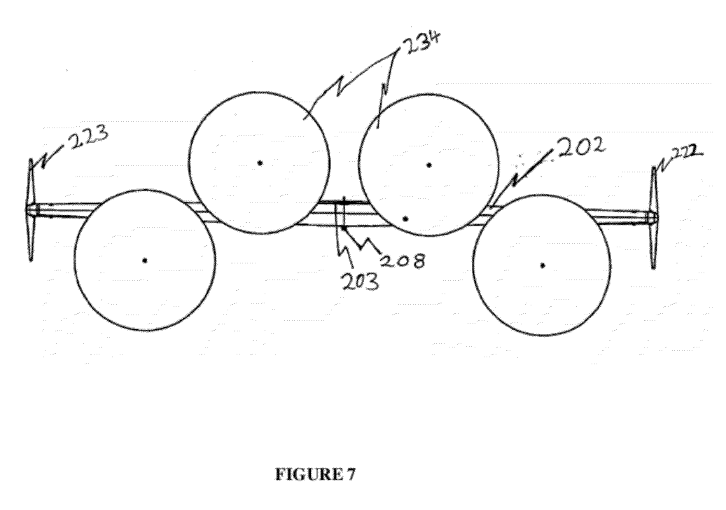

FIG. 7 illustrates a front view of embodiments of the present invention depicting the main wing 202 mounted centrally on the vertical axis between the motors located on the top and bottom pylons, such that the vertical distance from the wing to the propeller shafts is equal for the motors both above and below the wing. The propeller discs 234 are in front of the leading edge of the main wing 202 and positioned such that the wash from the propellers impinges on the main wing 202, thereby allowing the use of actuated aerodynamic surfaces such as elevons for roll and pitch control even at low forward airspeed of the vehicle. In some embodiments, the motors and propellers are configured such that the discs of the moving propellers cross the wing. The disc of the upper propellers cross the wing such that some of the air is forced back below the wing, and the disc of the lower propellers cross the wing such that some of the air is forced back above the wing. The payload mounting location 208 below the electronics enclosure 203 takes the form of a hole for passing through a bolt or screw to which payload can be attached. In some embodiments, payloads may be attached directly to the underside of the main wing or to the spar of the main wing. Some embodiments may have more or fewer mounting points that take the form or bolt or screw holes.

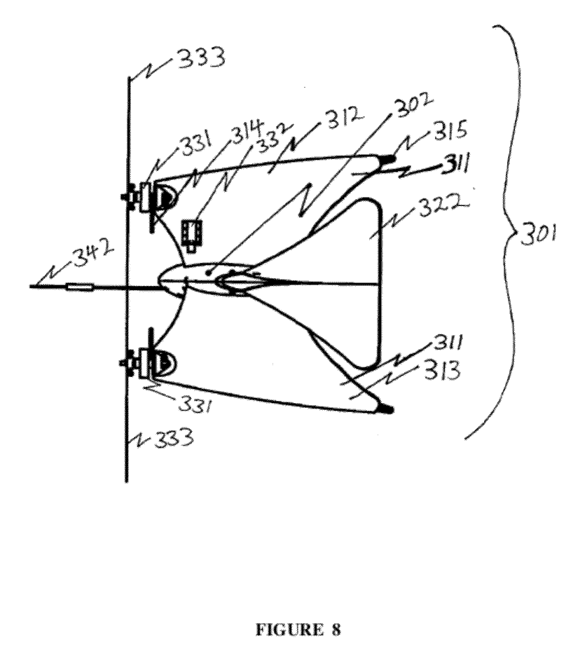

FIG. 8 is a side view of an aerial vehicle 301 from the left side depicting the vertical and longitudinal arrangement of propellers, motors, pylons and winglets according to some embodiments of the present invention. The main wing 302 has the motors 331 with propellers in a tractor arrangement mounted to the motor pylons 311 in such a way as to keep the propeller disc 333 ahead of the leading edge of the main wing 302. Furthermore, the motors 331 are also mounted on the pylons 311 ahead of the leading edge of the main wing 302. Mounting the motors 331 ahead of the leading edge of the main wing 302 allows the vehicle center of gravity to be ahead of the neutral point or aerodynamic center of the main wing 302 which allows the vehicle 301 to be statically stable in the longitudinal axis. The motors 331 are each held onto the pylons 311 with metallic clips 314 that allow for easy detachment of motors for repair and/or replacement. In some embodiments, the motor pylons 311 may be detachable from the main wing for easy stowage. The upper pylons 312 support two motors above the wing 302 and the lower pylons 313 support two motors below the wing 302. Landing pads 315 may be seen at the rear of each pylon 311 for use when the vehicle is on the ground.

The rear tips of the motor pylons 311, that is the end furthest away from the motor attach point, are the landing tips 315. These landing tips 315 are constructed in such a manner as to be able to survive landing loads multiple times without permanent deformation. In some embodiments, these landing tips might be sprung to better absorb landing loads. In other embodiments, these landing tips may be sacrificial, undergoing permanent deformation but preventing transfer of energy to the rest of the airframe and hence damage to the rest of the system 301. The winglet 322 is seen on the close end of the wing.

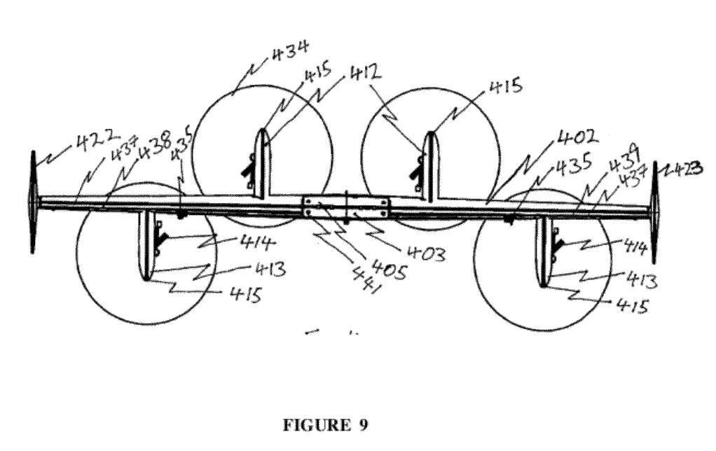

FIG. 9 is the rear view of an aerial vehicle depicting the relative position of the motor pylons 415, the electronics enclosure 403 and the aerodynamic control surfaces (elevons) according to some embodiments of the invention. The electronics enclosure 403 is located at the center of the main wing 402. The placement of this electronics enclosure 403 in the center allows mounting of the primary inertial measurement unit consisting of accelerometers, gyroscopes and magnetometers close to the geometric center of the vehicle which is ideal from the point of view of using the inertial measurement unit to calculate the vehicle's angular orientation or attitude. An inertial measurement unit mounted close to or at the center of the vehicle does not require translational corrections to the sensor data to calculate attitude, thereby reducing computational load on the microprocessor. Upper pylons 412 support motors above the wing and lower pylons 413 support pylons below the wing. Clips 414 may allow for easier removal of the motors from the wings and pylons. Winglets 422, 423 are placed on the ends of the wing 402.

The section of the main wing 402 adjacent to and including the trailing edge is movable and forms actuated aerodynamic control surfaces called elevons 437. The surfaces work by either deflecting in the same direction up or down on both the left half and the right half of the main wing, thereby changing the effective camber of the main wing and shifting the center of pressure fore or aft of the center of gravity thereby creating a pitch-up or pitch down moment on the vehicle. Alternatively, the left elevon 438 may deflect in the opposite direction to the right elevon 439, increasing the lift on one half of the main wing and decreasing it in the opposite half, thereby creating a roll moment on the vehicle. These elevons 437 work in conjunction with the differential thrust and differential torque on the motors to increase angular change authority. The use of actuated aerodynamic surfaces for control is especially desirable since disturbance forces in forward flight scale in proportion to the square of airspeed, but the control forces exerted by just the motors do not scale up as the square of the airspeed, thus creating the possibility that differential thrust and differential torque may not provide adequate control authority at high airspeeds. However, control forces exerted by actuated aerodynamic surfaces also scale in proportion to the square of the airspeed, thereby providing adequate control authority throughout the flight airspeed envelope. The actuated aerodynamic surfaces 437 are actuated using servos 435 in some embodiments, but other embodiments might utilize other types of actuators, such as screws, pneumatic pistons or hydraulic pistons. Yet other embodiments may not utilize actuated aerodynamic surfaces of the same size, changing the span or the chord depending on vehicle requirements. Other embodiments may utilize a plurality of actuated aerodynamic surfaces and might use surfaces to control yaw moment of the vehicle as well. Still other embodiments of the vehicle may not utilize aerodynamic surface at all if the design airspeed does not result in the saturation of the authority provided by differential thrust and/or differential torque. The electronics enclosure 403 may also have Light Emitting Diodes (LEDs) 441 to indicate status of batteries or other system conditions.

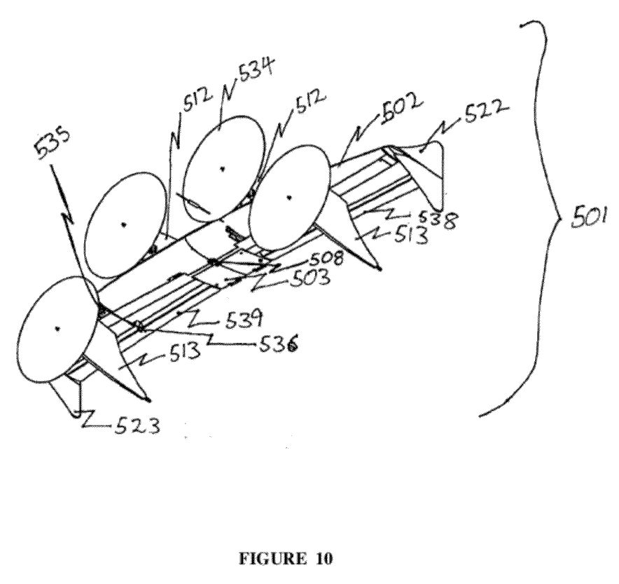

FIG. 10 is a bottom view of an aerial vehicle 501 depicting the actuated aerodynamic surfaces left elevon 538 and the right elevon 539, the electronics enclosure, and the linkage 536 that connects the elevons to the servos 535 according to some embodiments of the present invention. The servos 535 are mounted in the front half of the main wing 502 in order to allow the center of gravity of the vehicle 501 to be ahead of the neutral point or aerodynamic center of the main wing 502, thereby allowing the aircraft 501 to be statically stable in the longitudinal axis. The discs 534 of the spinning propellers are forward of the wing.

The winglets 522 and 523 are also visible, as are the motor pylons 512, 513 which add vertical surface area to provide spiral stability to the vehicle 501 by preventing sideslip, that is, motion in the direction along the span of the main wing 502 perpendicular to the direction of forward flight.

An electronics enclosure 503 may house the control system electronics for the system. The payload mounting location 508 below the electronics enclosure 503 may take the form of a ¼th inch hole for passing through a bolt or screw to which payloads can be attached. In other embodiments, the location and size of the mounting hole 508 may differ to accommodate different payloads.

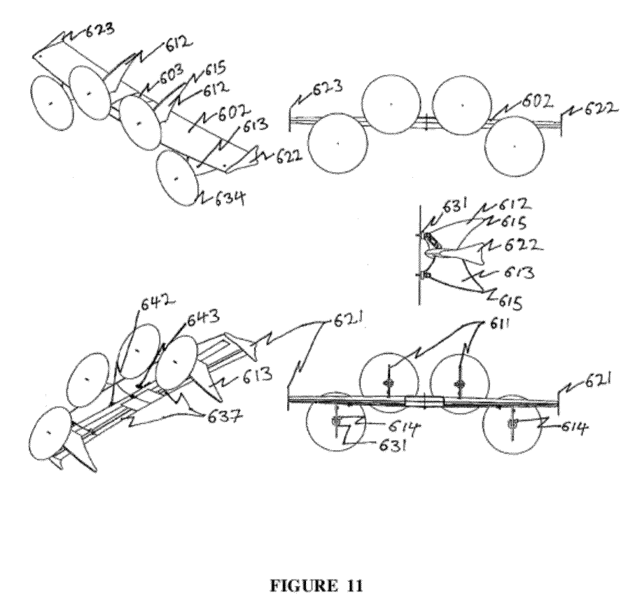

FIG. 11 illustrates an embodiment of the invention using smaller winglets 621 on the end of the wing 602. The primary function of the winglets in such embodiment is structural protection of the edge of the main wing 602, and they do not provide as much protection from sideslip travel or travel in the spanwise direction of main wing 602 due to reduced vertical surface area. The winglets 622, 623 may still assist with reduction in vehicle induced drag on account of interfering with vortices shedding at the tips of the main wing 602. The propellers 643 are seen spread in two dimensions.

The motor pylons 611 have a different shape and are not made up by joining two dimensional airfoil shapes with splines, but are essentially flat plates. While the flat plate nature of the upper pylons 612 and the lower pylons 613 reduces the sideslip angles at which they are effective at providing restoring force to the vehicle, it also reduces mass and difficulty of manufacture. This embodiment of the invention also incorporates a master switch 643 that can be used to shut off all electrical power to the vehicle's actuators and avionics thereby increasing safety and convenience to work in proximity to the vehicle. This embodiment may also incorporate a remote controller receiver antenna 642 embedded in the main wing 602. Such an arrangement may be used in other embodiments as well.

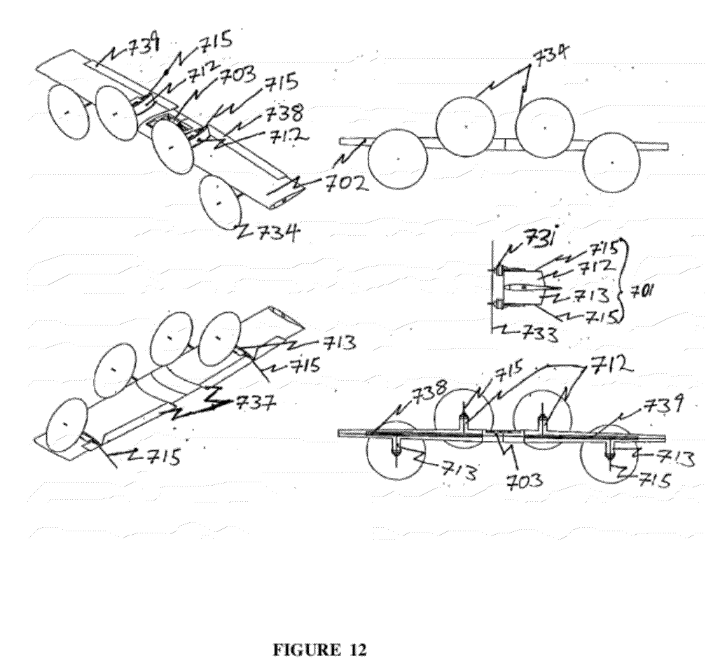

FIG. 12 illustrates an embodiment of an aerial vehicle 701 that does not incorporate winglets and also has motor pylons 712, 713 that are short and have a flat top instead of a rounded or domed setup. The flat sections are used to attach motor attachment structures made out of plastic or other material. Such motor attachment structures might use metal clips or screws for mounting of the motors 731. The lower pylon height results in motors 731 having lower separation from the surface of the main wing 702 which in turn results in a larger portion of the main wing 702 being blown by the propeller wash off the propeller discs 734. This increased propeller wash impingement on the main wing 702 and subsequently on the actuated aerodynamic surfaces 738, 739 increases their authority when the vehicle is hovering vertically or has low forward airspeed by artificially increasing local airspeed over the actuated aerodynamic surfaces 738, 739 by means of the propellers.

In such embodiments, the actuated aerodynamic surfaces 738, 739 are angled with respect to the leading edge of the main wing 702 and the trailing edge of the surfaces 738 and 739 extends beyond the trailing edge of the main wing 702. The extension of the actuated aerodynamic surfaces 738, 739 towards and beyond the trailing edge of the main wing 702 pushes the neutral point of the overall lifting surface for the vehicle formed by the main wing 702 combined with the actuated aerodynamic surfaces 738 and 739 towards the aft, i.e., towards the trailing edge, thereby potentially increasing the separation from the center of gravity of the vehicle 701, in turn increasing the longitudinal static stability of the vehicle. In such embodiment, the actuated aerodynamic surfaces 738, 739 may not be part of the main wing 702 but additional attachments composed of different materials than main wing 702, for examples the surfaces 738, 739 might be made of balsa wood while the main wing 702 is made of some type of foam.

Due to the short vertical dimension of the motor pylons 712, 713, landing tips 715 that take the form of wire or plastic extensions that exit the pylons 712, 713 at an angle such that the vertical separation between the landing tips 715 from the top pylons 712 and the bottom pylons 713 is adequate to allow a stable vertical landing without danger of the vehicle 701 toppling over.

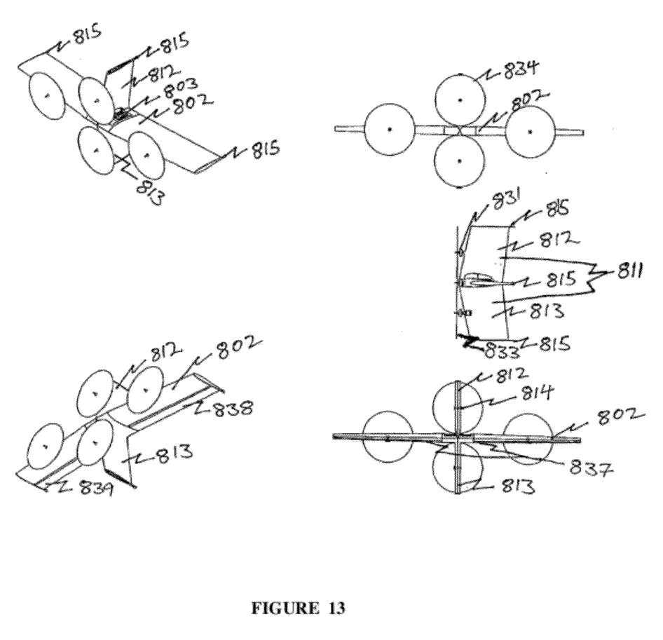

FIG. 13 illustrates an aerial vehicle configured in a “plus arrangement” where the motor pylons 811 take the form of top and bottom pylons 812, 813 with a large enough vertical dimension that the propeller discs 834 of the motors 831 mounted on such pylons 811 do not have their rotor wash impinging on the main wing according to some embodiments of the present invention. In some embodiments, additional motors 831 may be mounted directly to the leading edge of the main wing 802 to create blown actuated aerodynamic surfaces 838, 839 which in turn provide control forces in the pitch and the roll axes even at low forward airspeeds by deflecting this propeller wash. The pylons 811 with larger vertical dimensions have the added effect of increasing separation between the landing tips 815 in the vertical axis, thereby increasing stability of the vehicle in this axis when landing or when stationary on the ground. The landing tips 815 in the horizontal axis are incorporated into wingtip devices of the main wing 802.

The increased vertical dimension of the motor pylons 811 results in increased separation of the motors 831 and thus the propeller discs 834 in the vertical axis, which in turn leads to greater effect of propeller disc damping in the pitch axis, which in turn allows better control of the vehicle with higher usable proportional gains without inducing oscillations. The use of symmetric airfoil shapes for the motor pylons 811, as well as symmetric airfoil shapes for the wing 802, results in the center of lift maintaining position within a narrow range regardless of the angle of attack relative to wind of both the pylons and the wing. In other embodiments of the vehicle, a plurality of large vertical motor pylons 811 may be employed instead of just two as depicted in FIG. 13, with each top motor pylon 812 aligned with a corresponding bottom motor pylon 813 in the spanwise direction of the main wing 802.

The aerial vehicle may also feature an electronics bay 803 that is isolated from the high frequency vibrations of the airframe through being supported on suspension blocks of foam or rubber or other vibration absorbing materials. Such vibration isolation of the avionics bay 803 reduces noise picked up by the sensors thereby allowing better estimation of the vehicle attitude.

In some embodiments, two or more of the motors 831 mounted on the vertical motor pylons 811 might feature folding propellers such that the motors may be shut down in forward flight with propeller blades folded to reduce aerodynamic drag thus increasing endurance and range. In such embodiments, with the motors 831 on the vertical motor pylons 811 shut down, the forward thrust is provided by the propellers mounted directly to the leading edge of the main wing 802, the roll and pitch control is provided by the actuated aerodynamic surfaces (elevons) 838 and 839 while yaw control is provided by differential thrust of the motors mounted directly to the leading edge of the main wing 802.

In some embodiments which feature a plurality of actuated aerodynamic surfaces 838 on the port side of the main wing 802 and a plurality of actuated aerodynamic surfaces 839 on the starboard side of the main wing 802, yaw control might also be achieved with actuated aerodynamic surfaces by deflecting the surfaces on any one side of the main wing 802 in opposite directions, thereby increasing the drag on that side of the vehicle and creating a net yaw torque.

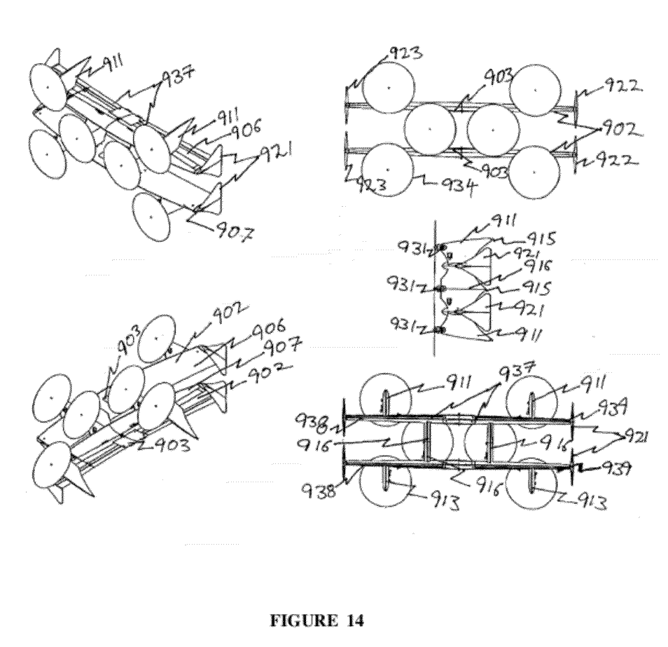

FIG. 14 depicts a multiwing aerial vehicle according to some embodiments of the present invention, created by replacing two of the motor pylons seen on other embodiments with connector pylons 916 that are attached onto wings at both ends and incorporate a motor attachment point in the middle of their span with a landing tip 915 directly behind this motor attach point 931. Such embodiments allow the utilization of existing airframes with minimum changes to increase the number of motors 931 providing lift for vertical flight as well as for increasing the lifting surface area or main wing area by providing multiple main wings 902, thereby allowing the carriage of heavier payloads and/or additional fuel in the form of extra batteries to increase the endurance and/or range of the vehicle. In the figure, an upper main wing 906 and a lower main wing 907 are depicted. In other embodiments, a third main wing or even more additional wings might be added utilizing a similar method, since the motor pylons 911 are identical in physical design and all are equally suited to being replaced with connector pylons 916 for vehicle extension.

The aerial vehicle may be unmanned and controlled by a ground controller using a remote control unit. In some embodiments, the ground controller may take inputs as would be used with a standard aircraft. For example, with a standard, tailed, aircraft with an elevator and rudder significantly rearward of the wing, a turn may be executed by first rolling the aircraft using a roll command which controls ailerons, and then once rolled the turn is initiated using an elevator up command, which now turns the rolled aircraft (as opposed to solely pitching up the wing as it would if the aircraft had not been rolled). Finally, once the new heading had been achieved, the aircraft could be rolled back to a flat posture. In the case of a tailless aerial vehicle, such as with some embodiments of the present invention, there is no rearward tail with elevator to receive such commands. Nonetheless, an operator would likely be familiar with, and be trained in, flying an aerial vehicle using such commands (for example, standard stick commands). An improvement in the control system of the present invention is that the remote control unit may be able to be controlled using standard (stick type) commands, which the control system of the aerial vehicle system then translates into appropriate commands which achieve the changes in attitude and heading which the ground controller was trying to convey. For example, when the remote control unit has a roll, and then elevator up, commands inputted, the control system may translate that input such that the elevator up (not possible with a tailless craft with no tail/elevator) is instead relayed as a differentiation in thrust of motors above the wing relative to motors below the wing. In this way, the ground controller is using a “synthetic” control system which takes inputs in the traditional sense and translates them to actual commands which are needed for the tailless aerial vehicle. In some aspects, the elevons may be used in addition to the thrust differentiation.

In another aspect, a turn coordination mode can be selected and used. In this mode, the stick control of the remote control unit will not control the aerial vehicle as a typical stick controller, but instead will allow for turns to be made just with the left or right motion of the stick. In this mode, the control system will automatically control the aerial vehicle to engage in a turn, which may include rolling the aerial vehicle and pitching the aerial vehicle up to make the turn, and then to roll back to flat. All of these actions may be made by the control system despite the input at the remote control unit only having had been a simple motion to the side.

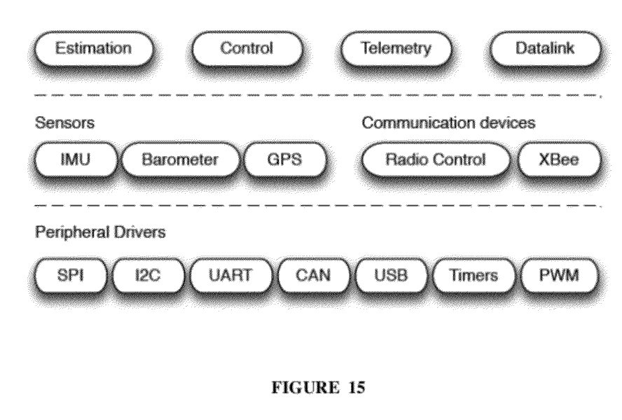

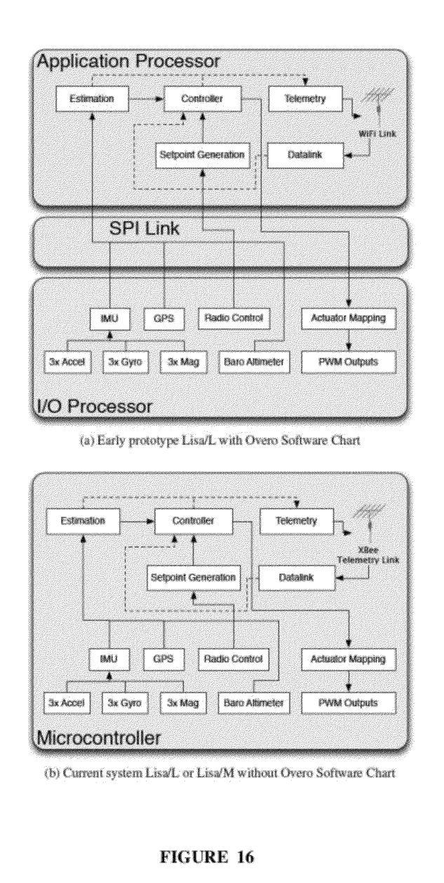

The on-board autopilot software is arranged into modules which allow the user to add or replace functionality by substituting individual modules, which are seen in FIG. 15. Much of the low level software can be reused across many projects, including this one. Sharing driver modules prevents allows development efforts to be focused on those modules which are unique to the project, such as the control algorithms. Additionally, the ability to easily swap modules to adapt to new hardware is very helpful. For example, during flight testing, the need was discovered for an Inertial Measurement Unit (IMU) capable of tracking wider rotation rates. Similarly, one could replace the radio control module to conform to local wireless regulations. A modular structure has enabled the developers to write simple unit test programs to facilitate rapid development of new modules. In early prototypes the vehicle-side software was divided into an I/O process and an autopilot process, as seen in FIG. 16. The autopilot ran as a Linux process on the Overo Gumstix module, while the I/O process ran on the STM32. The two processes ran in lock-step and communicated by passing messages over an SPI bus. After initialization, the autopilot process ran an event loop with a timer triggered periodic function to communicate with the I/O processor, run estimation, setpoint updates, and desired feedback and feed-forward control outputs. In order to ensure timely operation of the autopilot loop, the Linux kernel was patched using the PREEMPT-RT patch. Running the autopilot on a Linux kernel allows easy communication with the vehicle over WiFi, storage of logs onto a standard file system, and usage of standard network protocols and tools such as SSH to perform updates.

In current prototypes the autopilot process, containing es-timation and attitude control algorithms, was ported to the STM32 processor, decreasing the necessary hardware re-quirements and thus the overall cost of the system. In some embodiments of the present invention, the IMU may have three axis gyroscopes, magnetometers, and accelerometers.

Control Algorithms

In hover the vehicle is equivalent to a traditional quadcopter, but adding forward flight capability required a controller capable of handling a wide range of operating points. While the vehicle is aerodynamically stable and manually control-lable when gliding with thrusters disabled, correct thrust distribution among the various rotors requires active control to ensure stabilized flight. The vehicle must also be able to reliably recover from dangerous situations such as high speed dives.

Three major control modes have been implemented: hover/recovery, forward flight, and acrobatic flight. A nonlinear hover controller was developed which is suitable for recovery from any attitude, but acts as a normal hover controller without mode switching, as discussed with regard to Hover Mode, below. A simple user-friendly forward controller was implemented with a modification enabling it to smoothly transition from hover, as discussed with regard to Forward Mode, below. Finally an acrobatic controller was developed, as discussed with regard to Acrobatic Mode, below.

A North-East-Down (NED) navigation frame with bases {nx, ny, nz} is used. The aircraft's body frame has bases {bx, by, bz} with bx aligned with the motor thrusts and b sub y out the right wing, as seen in FIG. 17. The aircraft's attitude is expressed as the quaternion qn2b or the direction cosine matrix bRn.

All three flight modes utilize a different algorithm for setting a desired attitude setpoint qn2s, and use the same feedback law (but with different gains) for tracking the desired setpoint. The relative rotation from the body to setpoint frames is

q_{b2s}=q_{n2b}⁻¹*qₙ₂ₛ

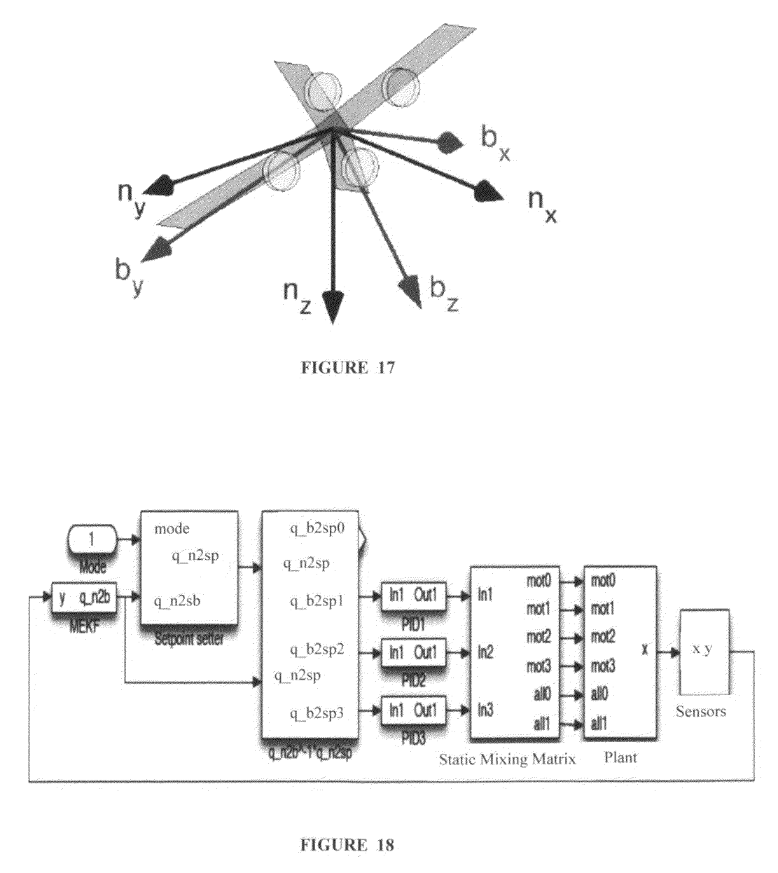

By construction, the vector part of qb2s (known as the error quaternion) is proportional to the rotation vector in the body frame. This rotates the body to the setpoint frame and it is well suited as the feedback signal for a 3D system expected to undergo large rotations. The error quaternion components are fed into three independent PID loops (using gyros for the derivative term), and the outputs are converted to body torques using differential thrust (increasing thrust in one motor and decreasing in the opposite motor) for by and by, as seen in FIG. 18. Elevons are actuated for bx in hover and forward flight.

Hover Mode

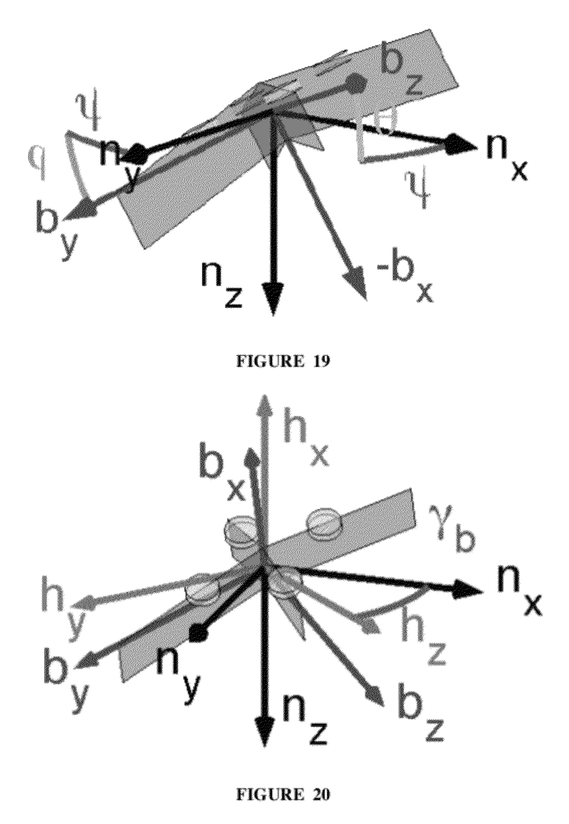

Euler angle controller—One way to construct a hover attitude setpoint is to use the bx by bz Euler angle sequence as in FIG. 19. A pilot or position hold outer loop would set ψ, ⊖, and ø setpoints as well as a thrust.

An Euler angle controller works well as long as ⊖ does not approach ±90. For large ⊖ unpredictable setpoint swings are apparent, and as ⊖ reaches and continues through ±90 the setpoint rotates 180 and causes loss of control. This is especially undesirable because the hover mode is used as an emergency recovery mode. One workaround is monitoring the attitude and switching between different Euler angle sequences when necessary, but a more elegant strategy has been implemented which is equivalent to an Euler angle controller for small angles, but has no singularity and exhibits smooth behavior over all attitudes.

Intermediate heading frame—A “heading” frame with bases {hx, hy, hz} and attitude quaternion qn2h is shown in FIG. 20. The heading angle is a substitute for ψ, representing the aircraft's rotation about nz for any attitude the aircraft may be in. Rotation qn2h is derived by solving for the rotation qb2h which aligns bx with -nz while having an Euler axis completely in the (by, bz) plane. This unique rotation can be simplified to

$${q}_{b 2 h} = ( \begin{matrix}cos ( \frac{\text{?}}{2} ) \\ 0 \\ \frac{{}^{b} R \text{?}}{\sqrt{{( {}^{b} R \text{?} )}^{2} + {( {}^{\text{?}} R \text{?} )}^{2}}} sin ( \frac{n}{2} ) \\ \frac{{}^{b} R \text{?}}{\sqrt{{( {}^{b} R \text{?} )}^{2} + {( {}^{\text{?}} R \text{?} )}^{2}}} sin ( \frac{n}{2} )\end{matrix} )$$

$$\text{?} \text{indicates text missing or illegible when filed}$$

where η=arc cos(−^{b}R₁₃ⁿ).

The heading frame quaternion is then

qₙ₂ₕ=q_{n2b}*q_{b2h}

and it is a simple matter to solve for γb. This substitute for was derived for its ability to work over all attitudes ,and it also has the advantage of encouraging large angle recoveries to include relatively little bx rotation (depending on the bounding constant bound). This is an excellent property for an emergency large-angle recovery controller because quadrotor vehicles generally have the least control authority about bx.

Control System—A desired heading setpoint ys is set by the pilot (by integrating the heading stick). The body heading γb is solved for and ys is bound to be within some angle bound (typically 45-90) of γb.

The desired heading frame qn2dh is then:

$${q}_{n2dh} = ( \begin{matrix}cos ( {γ}_{\text{?}} \text{?} ) \\ - sin ( γ \text{?} ) \\ cos ( γ \text{?} ) \\ sin ( γ \text{?} )\end{matrix} ) . \\ \text{?} \text{indicates text missing or illegible when filed}$$

The pilot (or outer loop) sets simultaneous ⊖y and ⊖z rotations (analogous to the Euler angles ⊖ and ø) which are scaled to a certain range (typically±120) and composed on the desired heading frame

$${q}_{n 2 s} = {q}_{n2dh} * ( \begin{matrix}cos ( \frac{1}{2} \sqrt{{θ}_{y}^{2} + {θ}_{x}^{2}} ) \\ 0 \\ \frac{{θ}_{y}}{\sqrt{θ \text{?} + θ \text{?}}} sin ( \frac{1}{2} \sqrt{θ \text{?} + θ \text{?}} ) \\ \frac{{θ}_{z}}{\sqrt{θ \text{?} + θ \text{?}}} sin ( \frac{1}{2} \sqrt{θ \text{?} + θ \text{?}} )\end{matrix} )$$

$$\text{?} \text{indicates text missing or illegible when filed}$$

forming the final hover setpoint.

Since the pilot can only see the body frame and not the desired setpoint frame, the angles ⊖y and ⊖z are rotated from heading to desired setpoint frames

$$( \begin{matrix}{θ}_{y} \\ {θ}_{s}\end{matrix} ) = ( \begin{matrix}cos ( {γ}_{s} - {γ}_{b} ) & - sin ( {γ}_{s} - {γ}_{b} ) \\ sin ( {γ}_{s} - {γ}_{b} ) & cos ( {γ}_{s} - {γ}_{b} )\end{matrix} ) ( \begin{matrix}{θ}_{y , pilot} \\ {θ}_{s , pilot}\end{matrix} ) .$$

For an autonomous position hold outer loop, angles are likewise input in NED and rotated to the desired setpoint frame.

Elevon reversal in descent—When the aircraft is executing a fast, vertical descent in hover mode (with bx aligned with -nz), elevon reversal occurs as the relative wind from behind overpowers the thrust of the propellers. This causes positive feedback in roll and pitch and must be avoided by reducing descent to a slower rate. If instability occurs before descent is slowed, applying throttle is an effective recovery technique. Our solution to this problem is to utilize the propellers to overcome any aerodynamic instabilities introduced as a result of the reversal. Thus, even at low overall throttle settings, the motors can spin up for attitude control using differential thrust for pitch and yaw and differential torque for roll. It is important of note that such a scenario almost always implies a throttle setting of “idle” or “off”, since higher throttle settings appear to provide adequate propwash to prevent reversal. An alternative strategy for high-speed descents is to maintain a post-stall alpha, on-wing attitude at low power settings instead of a vertical orientation.

Forward Mode

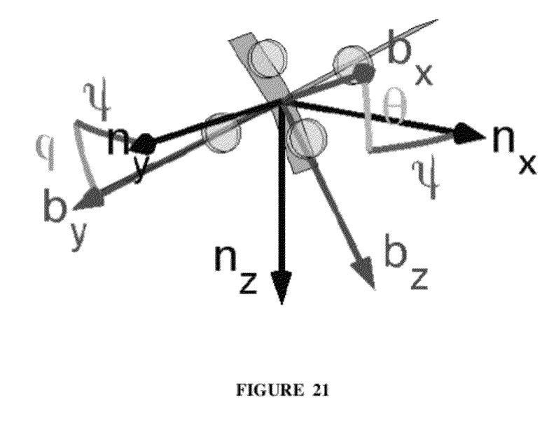

The forward mode setpoint is set using simple bz by bx Euler angles yr s, ⊖s, and øs, as seen in FIG. 21, with a minor modification to allow transition (see Transition below). These Euler angles are converted to the setpoint quaternion qn2s for feedback. The pilot sets ⊖s and øs setpoints directly and s is set automatically for turn coordination. Excellent performance has been achieved by measuring sideslip with a wind vane and regulating it to 0 degrees (or any angle set by the pilot's yaw stick) with a PID loop, but wind vanes were prohibitively expensive and unreliable for this vehicle. Regulating acceleration in by with a small integral gain into γb, just as ys was bound in hover.

Transition

Because the aircraft usually begins a hover to forward transition with the nose pointed up, the Euler angle singularity must be addressed. It is very useful to introduce a full-range pitch that goes from −90 to +180 degrees.

Full range pitch—The Euler angle direction cosine matrix is

$${}_{}^{b}{R}{}_{}^{n} = ( \begin{matrix}c θ c ψ & c θ s ψ & - \text{?} θ \\ c ψ s θ s φ - c φ s ψ & c φcψ + s θ s φ s ψ & c θ s φ \\ c φ c ψ s θ + s φ s ψ & - c ψ s φ + c φ s θ s ψ & c θ c φ\end{matrix} ) . \\ \text{?} \text{indicates text missing or illegible when filed}$$

Pitch is usually calculated from bRn using

θ=arc sin(−^{b}R₁₃^{o})

But to allow pitch to smoothly go through 90 degrees and continue to 180 degrees, it must be calculated using

$$\overline{θ} = \{ \begin{matrix}θ , & {if }^{b} {R}_{33}^{n} > 0 \\ arccos ( \frac{{}_{}^{b}{R}{}_{\text{?}}^{n}}{cos ( arctan ( \frac{{}_{}^{b}{R}{}_{\text{?}}^{n}}{{}_{}^{b}{R}{}_{\text{?}}^{n}} )} ) , & {if }^{b} {R}_{33}^{n} \leq 0\end{matrix} \\ \text{?} \text{indicates text missing or illegible when filed}$$

Effective yaw—At ⊖=+/−90 degrees, ψ and ø become mathematically indistinguishable. In order to set a robust setpoint an “effective yaw” must be extracted. In hover mode this was accomplished with the heading frame. A workaround is to pitch a virtual frame down to some angle ⊖max (around 60 degrees) before calculating yaw. First the required pitch rotation is calculated

$${θ}_{error} = {\overline{θ}}_{b} - {θ}_{max} . \\ If {θ}_{error} < 0 then {\overline{ψ}}_{b} = {ψ}_{b} . Otherwise \text{:}$$

$${q}_{n 2 \overline{ψ}} = {q}_{n2b} * ( \begin{matrix}cos ( \frac{1}{2} {θ}_{error} ) \\ 0 \\ - sin ( \frac{1}{2} {θ}_{error} ) \\ 0\end{matrix} )$$

and ψ_{b} is computed by converting qₙ₂ₕ to Euler angles and taking the yaw.

Transition—Upon beginning the transition a pitch slider angle

⊖ trans is initialized to the current θ̅_{b} (and the initial ψₙ is set

to ψ_{b}). The setpoint is then directly set by the pilot as in Subsec. Forward Mode with an additional rotation

$$( \begin{matrix}cos ( \frac{1}{2} {θ}_{trans} ) \\ 0 \\ sin ( \frac{1}{2} {θ}_{trans} ) \\ 0\end{matrix} )$$

composed upon the forward setpoint. Letting ⊖ trans slew linearly to 0 accomplishes a smooth transition. The setpoint pitch step that occurs when the pilot is setting a non-zero pitch setpoint when the transition is initiated can be easily subtracted out.

This scheme could be run in reverse for transitioning from forward to hover, but since hover mode is often used for emergency recovery it is safer to switch instantly to hover.

Acrobatic Mode

The forward mode is easy to fly but acrobatic maneuvers impossible because the pilot commands angles and not rates, and there are transient glitches when the pitch goes through ⊖max in the calculation of the effective ψ. A simple acrobatic mode was implemented where the pilot's control sticks set the setpoint angular velocity \vec{ω}.The setpoint qn2s is integrated according to the quaternion kinematic equation

$$\frac{d}{d t} ( \begin{matrix}{q}_{0} \\ {q}_{1} \\ {q}_{2} \\ {q}_{3}\end{matrix} ) = \frac{1}{2} ( \begin{matrix}0 & - {ω}_{1} & - {ω}_{2} & - {ω}_{3} \\ {ω}_{1} & 0 & {ω}_{3} & - {ω}_{2} \\ {ω}_{2} & - {ω}_{3} & 0 & {ω}_{1} \\ {ω}_{3} & {ω}_{2} & - {ω}_{1} & 0\end{matrix} ) ( \begin{matrix}{q}_{0} \\ {q}_{1} \\ {q}_{2} \\ {q}_{3}\end{matrix} )$$

Having the pilot set \vec{ω} in the body frame and rotating it by qb2s before integration ensures that the aircraft rotates in the direction the pilot wants.

At each time step, the setpoint is bound to within a certain rotation from the body. First the body to setpoint rotation is computed

q_{b2s}=q_{n2b}⁻¹*qₙ₂ₛ

Then the vector part of qb2s is bound one element at a time (to permit different bounds on different axes) creating q _{b̅2̅s}. Then the scalar part of q _{b̅2̅s} is normalized and the setpoint is recovered

Modifications

Letting the acrobatic setpoint decay exponentially to the body attitude gives aerodynamic feedback to the pilot and lets the vehicle fly more naturally, since the controller will no longer do everything it can to maintain an unreasonable setpoint such as very high angle of attack. Better tracking performance in all modes was achieved by augmenting the inner PID loops with feed forward derived from a second order reference model. Ideally gain scheduling would be implemented on airspeed and motor rpm, but in the absence of these sensors adequate performance was achieved using different fixed gains for each control mode.

Turn Coordination

In aviation, a common definition of “coordinated” flight is as follows: an aircraft is flying in a “coordinated” manner anytime that the nose of the aircraft is aligned with the actual direction of travel through the air mass at any given moment. In other words, an aircraft is flying in a “coordinated” manner any time that the nose of the aircraft is pointing directly into the relative wind. Thus, a turn is said to be coordinated if the bank angle and the yaw rate are adjusted such that the sideslip and lateral acceleration are zero. In a typical aircraft, this is done by using the rudder to initiate and hold a yaw rate during a banked turn. A tailless aircraft according to embodiments of the present invention depends on differential thrust to create and maintain yaw rates. Furthermore, in the non-acrobatic flight modes, the on-board control system is designed to allow single stick turns, i.e., the pilot simply needs to bank the aircraft using his roll stick, and the turn coordination is taken care of by the automatic control system. This automatic turn coordination is operational throughout the forward flight mode, whereas in the hover/recovery mode, it is active when the vehicle body x-axis (bx) is inclined at an angle greater than 30 from the vertical axis (-nz).

The turn coordination controller utilizes two branches in the control loop. The first is a roll to yaw feed-forward command. This is just a proportional yaw command based on the bank angle being requested by the pilot's roll stick. The next component of the turn coordinator is a proportional feedback controller which uses acceleration data along the body y-axis of the vehicle (by) as the input and zero acceleration along this axis as the reference to calculate a yaw command. The feed forward portion of the controller ensures a quick coordination response from the vehicle once a bank angle is commanded while the acceleration based feedback portion ensures any errors due to wind of other dynamic conditions are adequately compensated for.

Also, when any aircraft is banked, the lift vector from the main wing shifts away from the vertical axis. The vertical component of lift is then proportional to the cosine of the bank angle. Thus, banking an aircraft reduces the available vertical force, leading to a loss of altitude. In order to compensate for the loss in altitude, the lift generated by the main wing must be increased. This increase in lift can be achieved in two ways, firstly, by increasing the airspeed of the vehicle (Lift/Airspeed2), and secondly, by increasing the angle of attack of the wing to a higher coefficient of lift operating point. An embodiment of the turn coordination controller utilizes a roll to pitch feed-forward setup whereby the pitch angle of the wing is increased proportional to the bank angle commanded. The pitch angle, though not the same as an angle of attack, is calculated about the same axis, and is measurable without the use of additional sensors such as a multi-port pitot or a vane angle sensor. The pitch angle, and therefore angle of attack, is increased instead of airspeed since this allows a slower turn than increasing airspeed by commanding a higher throttle setting would permit, thereby reducing the reaction time required of novice pilots. Other embodiments of the controller may use roll to throttle feed-forward setups, or a combination of pitch angle increases and throttle increase. Some embodiments might also incorporate an angle of attack sensor, either in the form of a multi-port pitot or a vane angle sensor or some other sensor, and/or airspeed sensors such as a pitot-static tube, allowing feedback control of angle of attack and/or airspeed during turns instead of just feed-forward control. Yet other embodiments may include pressure, radio or GPS based altime-try, allowing a separate altitude feedback control system to operate alongside the turn coordinator to maintain altitude instead of the turn coordinator changing flight conditions such as angle of attack or airspeed.

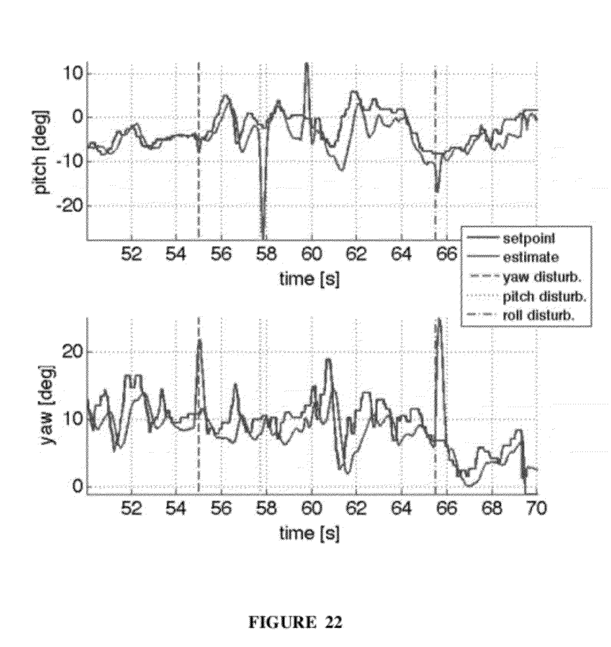

In some embodiments, a feature of the software package is the ability to obtain flight data via a telemetry link to the aircraft. FIG. 22 illustrates attitude data obtained in this fashion.

A significant improvement of the control system is that the aerial vehicle is able recover from disturbances in flight, such as from wind gusts. FIG. 22 illustrates data from a controlled hover flight where pitch, yaw and roll disturbance inputs were manually administered to the air frame. The setpoint, which is the commanded attitude from the pilot, is seen as not changing significantly during the disturbance. The estimate, which represents the actual airframe orientation, is seen to move significantly during the disturbances, seen at T=55, 58, and 65. The control system automatically recovers the aircraft attitude without need for input by the user.

As can be seen, the estimate shows a sharp deviation from setpoint when the disturbance input is received, since the airframe moves; however, recovery is quick and the airframe returns to the commanded setpoint, thereby demonstrating the effectiveness of the control system at overcoming disturbances.

The unique vertical take-off followed by autonomous transition capability is achieved by switching the setpoint from a hove mode to a forward flight mode on the remote control unit. This changes the pitch setpoint by 90 degrees. The setpoint is also referred to as the attitude reference. The user does not command the unit during this transition time, which may set to a variety of different durations, such as 3 seconds. Once the transition to forward flight has been made, the user may then fly the aircraft in forward flight mode as discussed above.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A method for the control of a remotely controlled aerial vehicle using a synthetic control system, the method comprising the steps of:
positioning the aerial vehicle such that the airfoil is oriented with its leading edges pointing upward and the thrust producing elements oriented to provide upward lift;
providing power to the thrust producing elements sufficient to cause the thrust producing elements to generate lift causing the aerial vehicle to rise, wherein said aerial vehicle comprises an inertial measurement unit adapted to estimate the attitude of the aerial vehicle; and
controlling the attitude of the aerial vehicle during its rise by varying the thrust of the thrust producing elements in response to variations in the estimate of the attitude of the aerial vehicle provided by the inertial measurement unit relative to an attitude setpoint, and wherein said setpoint is vertical during the take-off of the aerial vehicle, and wherein the attitude is controlled automatically by a control system on the aerial vehicle.

2. The method of claim 1 further comprising the steps of:
transitioning the aerial vehicle from a take-off orientation wherein the airfoil is facing vertically to a forward flight orientation wherein the airfoil is facing horizontally.

3. The method of claim 2 wherein the step of transitioning the aerial vehicle is commanded by a command sent from a remote control unit.

4. The method of claim 1 wherein the step of providing power to the thrust producing elements is commanded by a command sent from a remote control unit.

5. The method of claim 3 further comprising the step of sending a command from the remote control unit to alter the setpoint of the aerial vehicle.

6. The method of claim 5 further comprising the steps of:
receiving the command to alter the set point of the aerial vehicle at the onboard control system of the aerial vehicle, and
altering the attitude of the aerial vehicle until the estimate of the attitude of the aerial vehicle is within a pre-determined range from the setpoint.

7. A method for the control of a remotely controlled aerial vehicle using a synthetic control system, the method comprising the steps of:
using a remote control unit, inputting a standard stick turn command using a standard pitch and elevator control input;
sending wireless signals from the remote control unit to a control system on the remotely controlled aerial vehicle;
receiving wireless signal from the remote control unit to a control system on the remotely controlled aerial vehicle; and
translating the standard stick turn command into a set of commands including thrust differentiation of the motors on the aerial vehicle.

8. An aerial vehicle adapted for vertical takeoff and horizontal flight, said aerial vehicle comprising:
three or more thrust producing elements differentially spaced relative to the thrust direction of said thrust producing elements while said vehicle body is in vertical or horizontal flight;
one or more wings; and
a flight control system, said flight control system adapted to control the attitude of said aerial vehicle while taking off vertically by varying the thrust of the three or more thrust producing elements in response to the difference between an attitude estimate calculated from sensor inputs against a preset attitude setpoint.

9. The aerial vehicle of claim 8 wherein said flight control system is further adapted to control the attitude of said aerial vehicle while flying in forward flight by varying the thrust of the three or more thrust producing elements by in response to the difference between an attitude calculated from sensor inputs against a preset attitude setpoint.
